(19) United States
(12) Patent Application Publication
(10) Pub. No.: US 2017/0243384 A1
(43) Pub. Date: Aug. 24, 2017

(54) IMAGE DATA PROCESSING SYSTEM AND ASSOCIATED METHODS FOR PROCESSING PANORAMA IMAGES AND IMAGE BLENDING USING THE SAME

(71) Applicant: MEDIATEK INC., Hsin-Chu (TW)

(72) Inventors: Yu-Hao HUANG, Kaohsiung City (TW); Tsui-Shan CHANG, Tainan City (TW); Yi-Ting LIN, Taichung City (TW); Tsu-Ming LIU, Hsinchu City (TW); Kai-Min YANG, Kaohsiung City (TW)

(21) Appl. No.: 15/418,913

(22) Filed: Jan. 30, 2017

Related U.S. Application Data
(60) Provisional application No. 62/297,203, filed on Feb. 19, 2016.

(51) Int. Cl. G06T 11/60; G06T 3/60; G06T 3/00

(52) U.S. Cl. CPC G06T 11/60; G06T 3/0093; G06T 3/60; G06T 2210/22

(57) ABSTRACT

An image data processing system and associated methods for processing images and methods for image blending are provided. The method for processing panorama images in an image data processing system includes the steps of: receiving a plurality of source images from at least one image input interface, wherein the source images at least include overlapping portions; receiving browsing viewpoint and viewing angle information; determining cropped images of the source images based on the browsing viewpoint and viewing angle information; and generating a panorama image corresponding to the browsing viewpoint and viewing angle information for viewing or previewing based on the cropped images of the source images.

### CROSS REFERENCE TO RELATED APPLICATIONS

This application claims the benefit of U.S. Provisional Application No. 62/297,203, filed on Feb. 19, 2016, the entirety of which is incorporated by reference herein.

### BACKGROUND OF THE INVENTION

Field of the Disclosure

The disclosure relates to image processing, and, in particular, to an image data processing system and associated methods for processing panorama images and image blending using the same.

Description of the Related Art

With the development of computer technology, applications of panorama image have become more and more popular. A panorama image where a plurality of images may be combined or stitched together to increase the field of view (FOV) without compromising resolution is an image with an unusually large field of view, an exaggerated aspect ratio, or both. A panorama image, sometimes also called simply a “panorama”, can provide a 360 degree view of a scene. The stitching of the images, however, involves intensive computations and image processing.

Recently, electronic devices, such as mobile or handheld devices, have become more and more technically advanced and multifunctional. For example, a mobile device may receive email messages, have an advanced address book management application, allow for media playback, and have various other functions. Because of the conveniences of electronic devices with multiple functions, the devices have become necessities of life.

As user requirements and behaviors change, applications of panorama image have become necessities of the handheld devices. Social network server may perform the stitching of the images to generate a 360-degree panorama image and provide the panorama image for browsing or previewing by a viewer at a client device. Currently, when the viewer at the client side requests to browse or preview a 360-degree panorama image from a server, the entire 360-degree panorama image will be transmitted from the server to the client side and the client side device may then acquire corresponding portions of the 360-degree panorama image for displaying based on a viewpoint and a viewing angle of the viewer at local.

However, because the entire 360-degree panorama image is to be transmitted and the resolution of the 360-degree panorama image is typically higher than 4K, a huge amount of transmission bandwidth is required and the local system may need larger computing resources for processing the 360-degree panorama image, thereby consuming more power.

Accordingly, there is demand for an intelligent image data processing system and an associated method for processing panorama images to solve the aforementioned problem.

### BRIEF SUMMARY OF THE DISCLOSURE

A detailed description is given in the following implementations with reference to the accompanying drawings.

In an exemplary implementation, a method for processing images in an image data processing system is provided. The method for processing panorama images in an image data processing system includes the steps of: receiving a plurality of source images, wherein the source images at least include overlapping portions; receiving browsing viewpoint and viewing angle information; determining cropped images of the source images based on the browsing viewpoint and viewing angle information; and generating a perspective or panorama image corresponding to the browsing viewpoint and viewing angle information for viewing or previewing based on the cropped images of the source images.

In another exemplary implementation, a method for blending a first image and a second image in an image data processing system to generate a blended image is provided. The method includes the steps of: determining a seam between the first image and the second image based on corresponding contents of the first image and the second image; calculating a distance between the seam and at least one pixel of the first image and the second image to generate a distance map; and blending the first image and the second image to generate the blended image according to the distance map.

In yet another exemplary implementation, an image data processing system is provided. The image data processing system includes at least one image input interface and a processor. The image input interface is configured to receive a plurality of source images, wherein the source images at least comprise overlapping portions. The processor is coupled to the image input interface and configured to receive the source images from the image input interface, receive browsing viewpoint and viewing angle information, determine cropped images of the source images based on the browsing viewpoint and viewing angle information and generate a perspective or panorama image for previewing based on the cropped images of the source images.

In yet another exemplary implementation, a method for processing images performed between an image data processing system and a cloud server coupled thereto is provided, wherein the cloud server stores a plurality of source images. The method includes the steps of: receiving, at the cloud server, browsing viewpoint and viewing angle information from the image data processing system; determining, at the cloud server, cropped images of the source images based on the browsing viewpoint and viewing angle information; and transmitting, at the cloud server, the cropped images of the source images to the image data processing system; such that upon receiving the cropped images from the cloud server, the image data processing system generates a perspective or panorama image based on the cropped images of the source images for viewing or previewing.

### BRIEF DESCRIPTION OF THE DRAWINGS

The disclosure can be more fully understood by reading the subsequent detailed description and examples with references made to the accompanying drawings, wherein:

FIG. 1 is a diagram of an image data processing system in accordance with an implementation of the disclosure;

FIG. 2 is a flow chart of a method for processing a panorama image formed by multiple source images in an implementation of the disclosure;

FIG. 3 is a flow chart of a method for blending two images in another implementation of the disclosure;

FIG. 4 is a diagram of the source images, a panorama image of the source images and cropped regions corresponding to the user perspective viewpoint and viewing angle in accordance with an implementation of the disclosure;

FIG. 5A is a diagram of a result of geographical coordinate rotation and sensor rotation in accordance with an implementation of the disclosure;

FIG. 5B is a diagram of a projection plane used in the geographical coordinate rotation;

FIG. 5C is a diagram of a projection plane used in the sensor in accordance with some implementations of the disclosure;

FIG. 6 is a diagram of a rotation operation in accordance with an implementation of the disclosure;

FIG. 7A is a diagram of an image blending process in accordance with an implementation of the disclosure;

FIG. 7B is a diagram of a table for determining the alpha value based on the distance information in the distance map in accordance with an implementation of the disclosure;

FIG. 8 is a diagram of a blend mask used to create the panoramic image in accordance with an implementation of the disclosure;

FIG. 9 is a diagram of an image data processing system for providing video upload and playback with a cloud server in accordance with another implementation of the disclosure;

FIG. 10 is a flow chart of a method for processing panorama images performed between an image data processing system and a cloud server in accordance with another implementation of the disclosure;

FIG. 11 is a diagram of a mapping table for the spherical projection process in accordance with an implementation of the disclosure; and

FIG. 12 is a diagram of a memory buffer reusing of image blending process in accordance with an implementation of the disclosure.

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

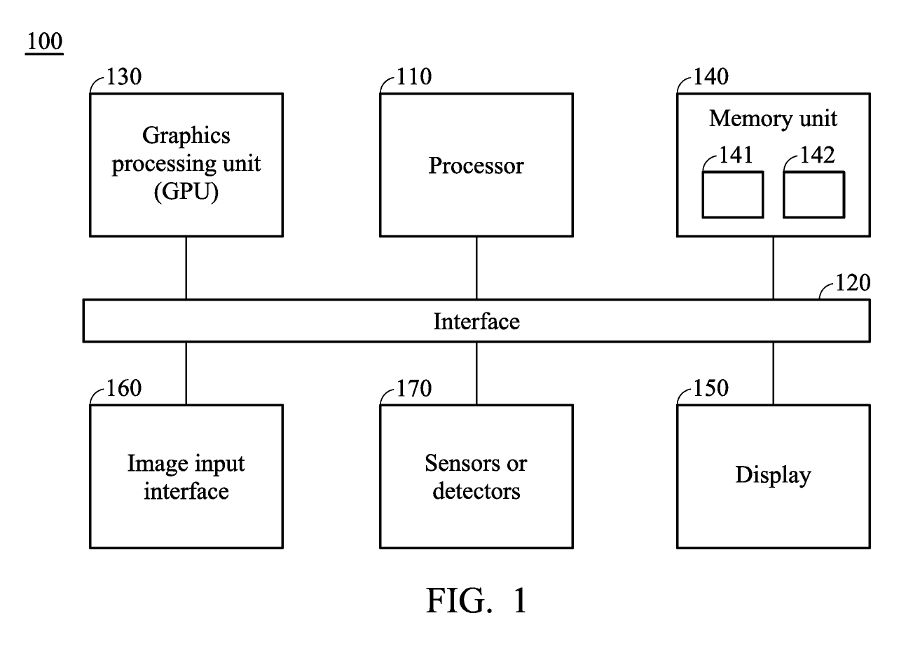

FIG. 1 is a diagram of an image data processing system in accordance with an implementation of the disclosure. The image data processing system 100 can be a mobile device (e.g., a tablet computer, a smartphone, or a wearable computing device) a laptop computer capable of processing image or video data or can be provided by more than one device. The image data processing system 100 can also be implemented as multiple chips or a single ship such as a system on chip (SOC) or a mobile processor disposed in a mobile device. For example, the image data processing system 100 comprises at least one of a processor 110, an interface 120, a graphics processing unit (GPU) 130, a memory unit 140, a display 150, at least one image input interface 160 and a plurality of sensors or detectors 170. The processor 110, the GPU 130, the memory unit 140 and the sensors or detectors 170 can be coupled to each other through the interface 120. The processor 110 may be a central processing unit (CPU) general-purpose processor, a digital signal processor (DSP), or any equivalent circuitry, but the disclosure is not limited thereto. The memory unit 140, for example, may include a volatile memory 141 and a non-volatile memory 142. The volatile memory 141 may be a dynamic random access memory (DRAM) or a static random access memory (SRAM), and the non-volatile memory 142 may be a flash memory, a hard disk, a solid-state disk (SSD), etc. For example, the program codes of the applications for use on the image data processing system 100 can be pre-stored in the non-volatile memory 142. The processor 110 may load program codes of applications from the non-volatile memory 142 to the volatile memory 141, and execute the program code of the applications. The processor 110 may also transmit the graphics data to the GPU 130, and the GPU 130 may determine the graphics data to be rendered on the display 150. It is noted that although the volatile memory 141 and the non-volatile memory 142 are illustrated as a memory unit, they can be implemented separately as different memory units. In addition, different numbers of volatile memory 141 and/or non-volatile memory 142 can be also implemented in different implementations. The display 150 can be a display circuit or hardware that can be coupled for controlling a display device (not shown). The display device may include either or both of a driving circuit and a display panel and can be disposed internal or external to the image data processing system 100.

The image input interfaces receives source images, such as image data or video data. In one implementation, the image input interfaces 160 can be equipped with image capture devices for capturing the source images. The image capture devices may comprise imaging sensors which may be a single sensor or a sensor array including a plurality of individual or separate sensor units. For example, each of the image capture devices can be an assembly of a set of lenses and a charge-coupled device (CCD), an assembly of a set of lenses and a complementary metal-oxide-semiconductor (CMOS) or the like. In one implementation, for example, the image capture devices can be multiple cameras with a fisheye lens. In another implementation, the image input interfaces 160 can receive the source images from external image capture devices.

The image input interfaces 160 can obtain source images (e.g., fisheye images) and provide the source images to the processor 110 during recording. The processor 110 may further include an encoder (not shown) to obtain the source images and encode the source images to generate encoded image, such as encoded video bitstream, in any suitable media format compatible with current video standards such as the H.264(MPEG-4 AVC) or H.265 standard. The encoder may be, for example, a standard image/video encoder or an image/encoder with pre-warping function, but the disclosure is not limited thereto. When the encoder is the image/video encoder with pre-warping function, it may further perform a remapping or warping operation on the encoded video bitstream during encoding to remove distortion on the original source images or video data. The processor 110 may further include a decoder (not shown) to decode the encoded video bitstream to obtain the source images using a suitable media format compatible with the video standard used by the encoded video bitstream such as the H.264(MPEG-4 AVC) or H.265 standard.

The sensors or detectors 170 may provide sensor data for providing orientation information regarding the motion corresponding to the image data processing system 100. To be more specific, the sensors or detectors 170 can measure/provide the orientation information (e.g. a tilt angle) of the image data processing system 100 and provide the measured orientation information to the processor 110. The sensors or detectors 170 may include, for example but not limited to, one or more of gyro sensor, acceleration sensor, gravity sensor, compass sensor (e.g. E-compass), GPS and the like. For example, the sensors or detectors 170 can use the acceleration sensor or the gravity sensor to measure the tilt angle relative to the ground, or use the compass sensor to measure an azimuth angle of the image data processing system 100. The sensor data associated with the sensors or detectors 170 may be logged/collected while image or video recording. This may include information regarding the movement of the device from the device's accelerometer and/or the rotation of the device based on the device's gyroscope. In some implementations, although not shown, the image data processing system 100 may comprise other functional units, such as a keyboard/keypad, a mouse, a touchpad, or a communication unit, such as an Ethernet card/chipset, a Wireless-Fidelity (WiFi) card/chipset, a baseband chipset and a Radio Frequency (RF) chipset for cellular communications.

The processor 110 can perform the method for processing panorama images and method for image blending of the present disclosure, which will be discussed further in the following paragraphs.

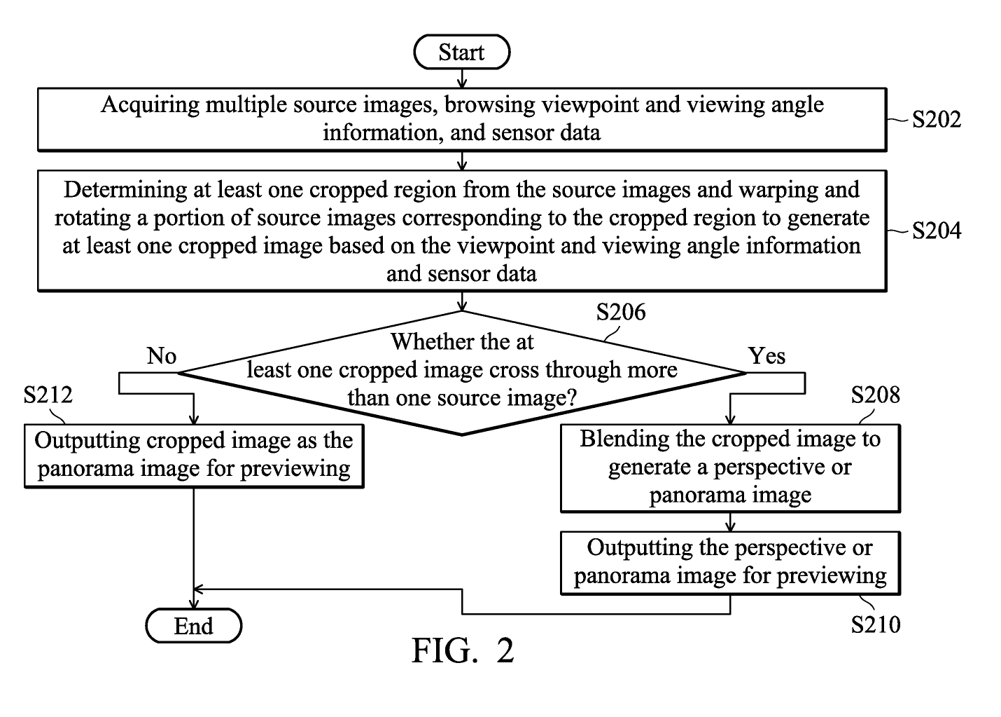

FIG. 2 is a flow chart of a method for processing a panorama image formed by multiple source images in an implementation of the disclosure. The method may be performed by the image data processing system 100 in FIG. 1, for example. The image data processing system 100 of FIG. 1 is utilized here for explanation of the flow chart, which however, is not limited to be applied to the image data processing system 100 only.

In step S202, when a viewer request to preview or browse a panorama image, multiple source images of the panorama image, sensor data, and browsing viewpoint and viewing angle information are acquired. To be more specific, the source images may be received by the image input interfaces 160 and the browsing viewpoint and viewing angle information for browsing the panorama image provided by the viewer may be acquired by the processor 110, the sensor data may be obtained by the sensors or detectors 170 and step S202 may be performed by the processor 110 in FIG. 1, for example. The viewing angle information may be determined based on the FOV of the image capture devices 160. An input sensing position which represents the viewing area and a portion of full image can be acquired. The sensing position represents a portion of original display image, wherein the position information may come from user-defined or pre-defined, touch signal from a display panel or sensors 170 such as Gyro sensor, G sensor and other sensors.

The source images may at least have overlapping or non-overlapping portions. The source images can be combined into a full panorama image based on the overlapping portions. The panorama image represents a combination of source images. There are various ways to construct the panorama image with panoramic views. One implementation combines the projections from two cameras with a fisheye lens, for example. Each of the two fisheye cameras will capture about half of the panorama and two may provide a full panorama image. In some implementations, the combination may be, for example, by a side-by-side or top-bottom combination without any processing. In other implementations, the combination may be a state-of-the-art spherical or cubic format with processing. For example, the source images can be two fisheye images and the two fisheye images can be blended by a side-by-side combination or by a state-of-the-art spherical or cubic format to form the panorama image or file. The panorama image or file may be stored in the local storage (e.g., the non-volatile memory 142) or it can be stored in the cloud or network. In some other embodiments, more than two cameras may be used to capture the source images to be combined into a full panorama image based on the overlapping portions.

After the source images, the browsing viewpoint and viewing angle information and sensor data are acquired, in step S204, at least one cropped region from the source images is determined and a portion of source images corresponding to the cropped region are warped and rotated to generate at least one cropped image based on the viewpoint and viewing angle information and sensor data. The step S204 may be performed by the processor 110 in FIG. 1, for example. To be more specific, the processor 110 may determine one or more cropped regions corresponding to the user perspective viewpoint and viewing angle from the source images and use the portion of source images corresponding to the cropped region to generate one or more cropped images.

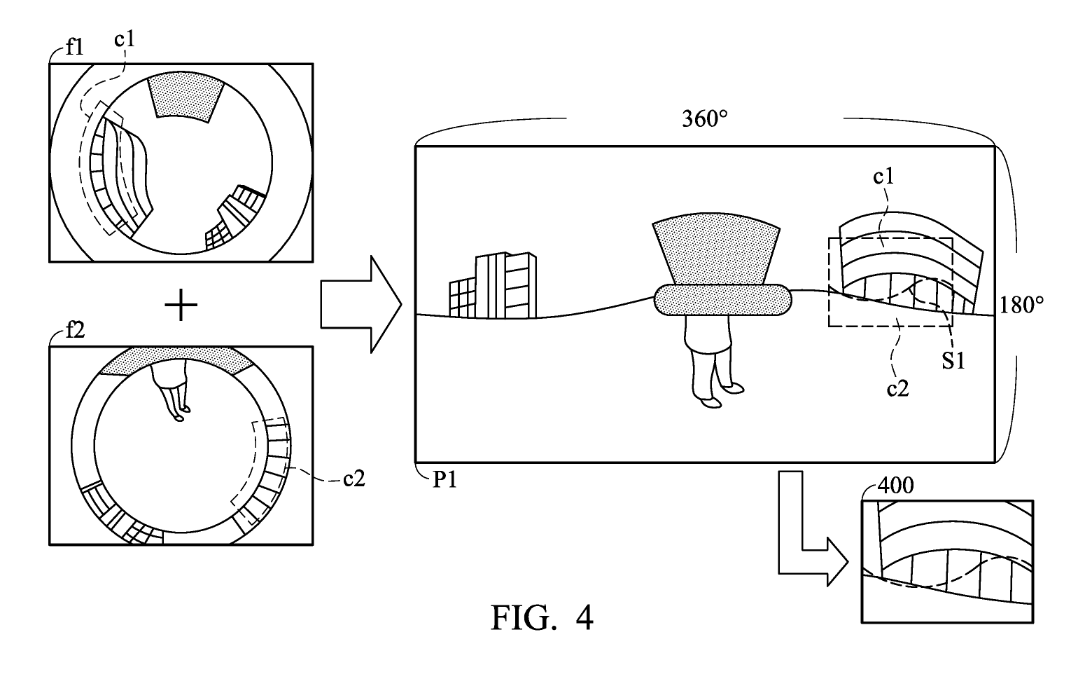

FIG. 4 is a diagram of the source images, a panorama image of the source images and cropped regions corresponding to the user perspective viewpoint and viewing angle in accordance with an implementation of the disclosure. In this implementation, the source images are first fisheye image f1 and second fisheye image f2, and the first fisheye image f1 and the second fisheye image f2 can be combined to form a 360×180 degree panorama image P1 and the first and second fisheye images f1 and f2 are deemed to be overlapping in the vertical direction of the panorama image P1. So, there is a region in the panorama image P1 which only belongs to the first fisheye image f1, and a region in the panorama image P1 which only belongs to the second fisheye image f2. In addition, there is an overlapping region in the panorama image P1 where pixels can be chosen from either the first fisheye image f1 or the second fisheye image f2 or some combination or calculation based thereon. A sensing position which represents the viewing area and a portion of the full panorama image can be determined based on user's viewpoint and viewing angle. As shown in FIG. 4, a cropped image C1 from the first fisheye image f1 and a cropped image C2 from the second fisheye image f2 are cropped images 400 corresponding to the user's viewpoint and viewing angle, wherein a seam S1 may exist between the cropped images C1 and C2 in the cropped images 400. For the purposes of description, the number of fisheye images is 2 in the aforementioned implementation. One having ordinary skill in the art will appreciate that a different number of fisheye images can be used to generate a panorama image.

To generate the cropped images (e.g., 400 of FIG. 4), the selected portions of images are transferred or mapped to spherical images using a spherical projection and the spherical images are then rotated based on sensor data. To be more specific, the processor 110 may perform rotating and warping operations at the same time to obtain the spherical images. In some implementations, the processor 110 may perform rotating and warping operations to obtain the spherical images by transferring the cropped images of the source images to spherical images based on the browsing viewpoint and viewing angle information, warping and rotating the spherical images to generate rotated images based on the viewing angle information and sensor data collected by the sensor 170 of the image data processing system 100.

The rotating operation may comprise a geographical coordinate rotation followed by a sensor rotation. The geographical coordinate rotation is to convert the source images to a spherical domain based on the viewpoint and viewing angle information. In geographical coordinate rotation, given (Φ, θ) for latitude and longitude as the viewpoint information, the rotation matrix R_{geographical} for the geographical coordinate rotation can be defined as blow:

R_{geographical}=R_{z}(Φ)*R_{y}(θ);

The sensor rotation is to convert the projection plane to rotate them to the desired orientation and to calculate the region of interest (ROI) by rotating the projection plane. In sensor rotation, given (α, β, γ) for pitch, roll and yaw, the rotation matrix Rsensor for the sensor rotation can be defined as below:

Rₛₑₙₛₒᵣ=R_{z}(γ)*R_{y}(β)*Rₓ(α);

and the final rotation matrix R can be defined as blow:

R=Rₛₑₙₛₒᵣ*R_{geographical}

Then, the rotated image Out can be determined by following formula using a source image In:

Out=R*In,

where

$${R}_{x} ( φ ) = ( \begin{matrix}1 & 0 & 0 \\ 0 & cos φ & sin φ \\ 0 & - sin φ & cos φ\end{matrix} )$$

$${R}_{y} ( θ ) = ( \begin{matrix}cos θ & 0 & - sin θ \\ 0 & 1 & 0 \\ sin θ & 0 & cos θ\end{matrix} )$$

$${R}_{z} ( ψ ) = ( \begin{matrix}cos ψ & sin ψ & 0 \\ - sin ψ & cos ψ & 0 \\ 0 & 0 & 1\end{matrix} )$$

In some implementations, the step of rotating the spherical images based on the sensor data may further comprise determining a projection plane based on the viewing angle information, rotating the projection plane based on the sensor data, and rotating the spherical images to generate the rotated images using the rotated projection plane.

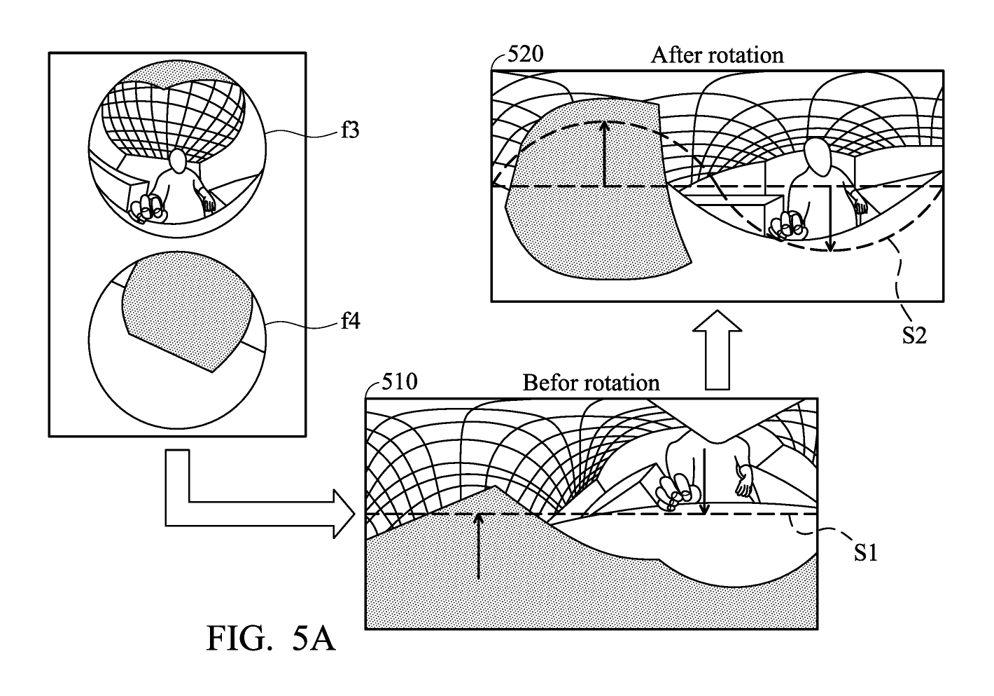

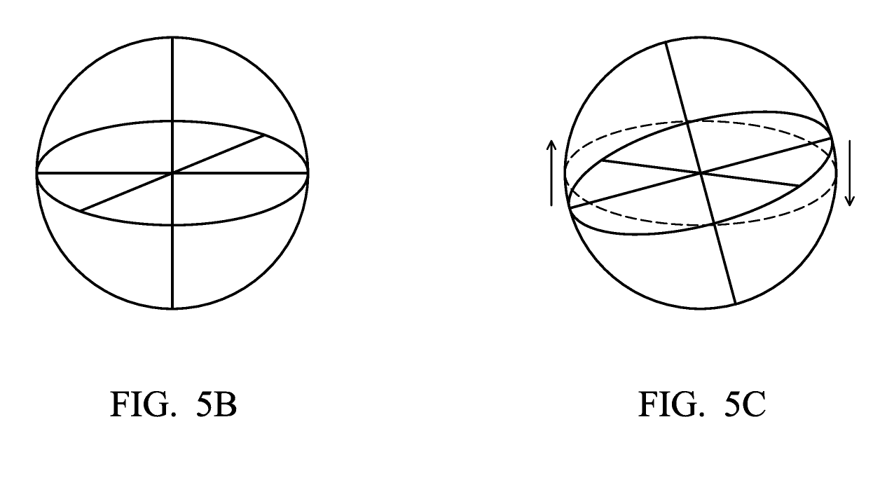

FIG. 5A is a diagram of a result of geographical coordinate rotation and sensor rotation in accordance with an implementation of the disclosure. FIG. 5B is a diagram of a projection plane used in the geographical coordinate rotation and FIG. 5C is a diagram of a projection plane used in the sensor in accordance with some implementations of the disclosure. As shown in FIG. 5A, after two source images f3 and f4 are performed with the geographical coordinate rotation using the projection plane shown in FIG. 5B and before the sensor rotation is performed, a panorama image 510 is generated in which there is a number of vision effect distortions in the panorama image 510 (e.g., the position of ceilings or sky is not on the upper side of the panorama image 520 and the position of floor is not on the lower side of the panorama image 520) due to the motion of the image data processing system 100. After the panorama image 510 is performed with the sensor rotation using the projection plane shown in FIG. 5C, a panorama image 520 is generated in which there is no such distortion in the panorama image 520, so as to make the position of ceilings or sky on the upper side of the panorama image 520 and the position of floor on the lower side of the panorama image 520. Optionally, the resultant panorama image 520 may be rotated certain degrees (e.g., 180 degrees in a counter-clockwise direction) to restore the image to its original orientation.

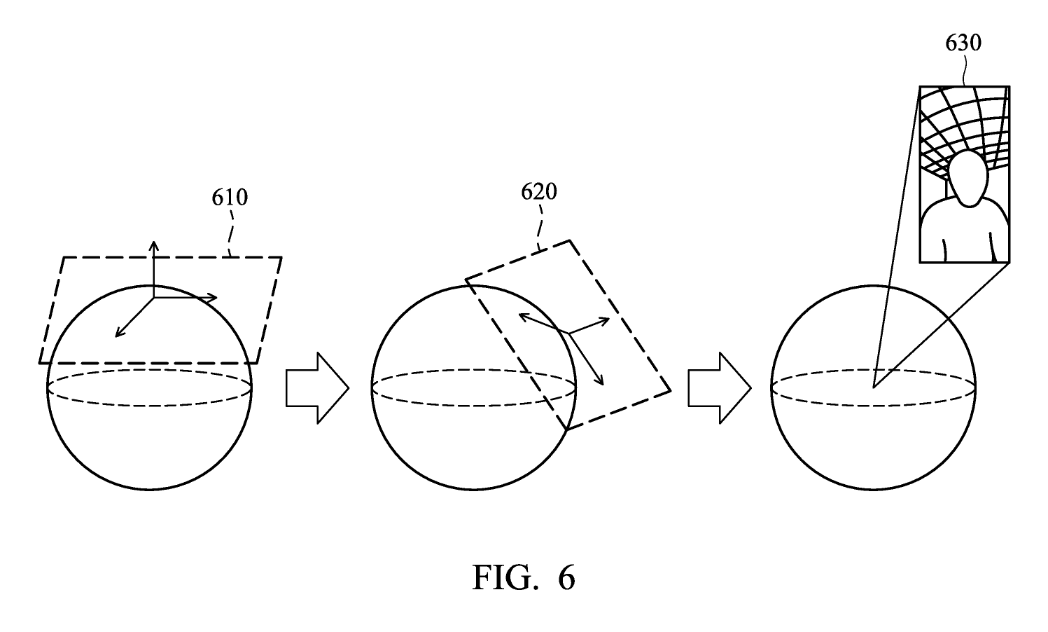

FIG. 6 is a diagram of a rotation operation in accordance with an implementation of the disclosure. As shown in FIG. 6, a projection plane 610 is first determined based on the viewing angle information. After a sensor rotation is performed, the projection plane 610 is rotated to be a projection plane 620 based on the sensor data. Then, the spherical images are rotated using the rotated projection plane to generate the rotated images 630.

Referring again to FIG. 2, after the at least one cropped image is generated, in step S206, it is then determined whether the at least one cropped image cross through more than one source image. The step S206 may be performed by the processor 110 in FIG. 1, for example. To be more specific, the processor 110 may determine whether the at least one cropped image cross through more than one source image based on viewpoint and viewing angle information and image blending is performed when the cropped images belong to more than one source image.

If the at least one cropped image does not cross through more than one source image (No in step S206), in step S212, which means that the cropped images come from a same source image, the cropped images are outputted as the panorama image for previewing.

If the at least one cropped image crosses through two or more source images (Yes in step S206), which means that the cropped images come from different source fisheye image, in step S208, an image blending is performed on the cropped images to generate a perspective or panorama image and the perspective or panorama image is then outputted for previewing (step S210).

In one implementation, alpha blending is applied in the image blending process. In other implementations, the blending method can also be any well-known blending algorithms, such as pyramid blending or other blending algorithms, and the disclosure is not limited thereto. To be more specific, the processor 110 uses an alpha blending to blend the cropped images at a seam boundary to eliminate irregularities or discontinuity surrounds the seam caused by the overlapping portions of the source images. The alpha value provides a blending ratio for overlapped pixels from the pair of images in the vicinity of the seam.

In one implementation, the blended image Iblend in the left portion can be determined by the following formula: Iblend=α Ileft+(1−α)Iright; where Ileft and Iright are images to be blended in the left portion and right portion of Iblend respectively. However, it should be understood that the disclosure is not limited thereto. For example, in another implementation, the blended image Iblend in the right portion can also be determined by the following formula: Iblend=α Iright+(1−α) Ileft.

The alpha value α can be determined by, for example, a pre-defined table, but the disclosure is not limited thereto. The distance values can be quantized in the pre-defined table as a weight for blending ratio for blending the pair of images. For example, the distance value ranging from 0-2 is assigned with a same alpha value 0.5, the distance value ranging from 2-4 is assigned with a same alpha value 0.6 and so forth.

The alpha value α indicates a blending ratio for blending the pair of images. For example, if a distance from a specific pixel to the seam is 2, the alpha value α is 0.5, which means that the specific pixel in the blended image is approximately 50% blending ratio between overlapped pixels of the pair of images (i.e., Iblend=0.5*Ileft+0.5*Iright).

In this implementation, the seam can be any line (e.g., a straight line, a curved line or any other line). Thus, a distance map is needed. The distance map can be generated in the warping step and it can be applied to image blending.

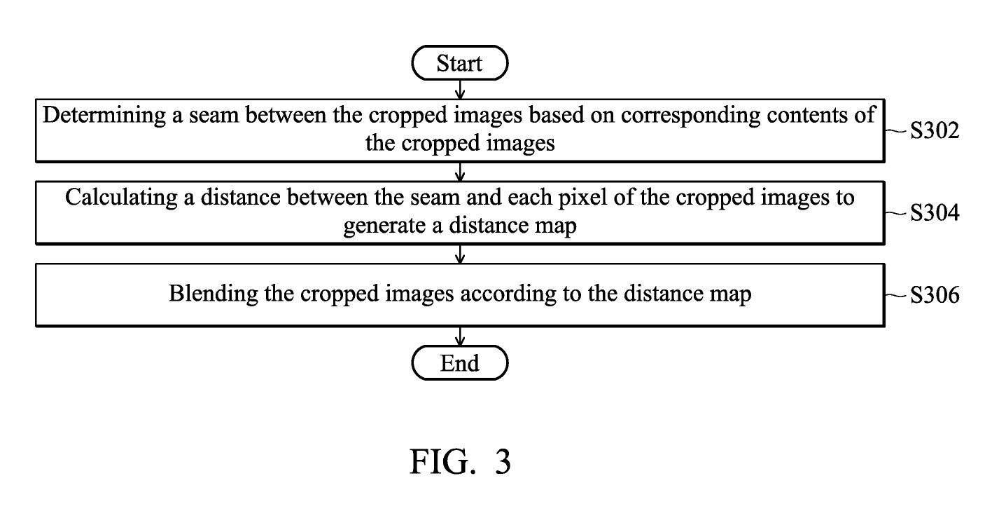

FIG. 3 is a flow chart of a method for blending two images in another implementation of the disclosure. The method may be performed by the image data processing system 100 in FIG. 1, for example.

During the warping step, a seam between the two images is first determined based on contents of the two images (step S302). To be more specific, each pair of pixels of the two images is compared to determine a location of a seam, wherein the seam is defined as a boundary line of two images while image blending.

Then, a distance map is generated by calculating a distance from the determined seam and each pixel of the two images (step S304). For example, the distance value for a pixel close to the seam is set to smaller than that for a pixel away from the seam. The distance values of all of the pixels of the two images are calculated and stored in the distance map. In some other embodiments, the distance value of at least one or part of or all of the pixels of the two images are calculated and stored in the distance map.

After the distance map is generated, the two images are blended to generate a blended image using the distance map (step S306). For example, the distance map can be used to determine the alpha value to use the alpha blending to process on the two images.

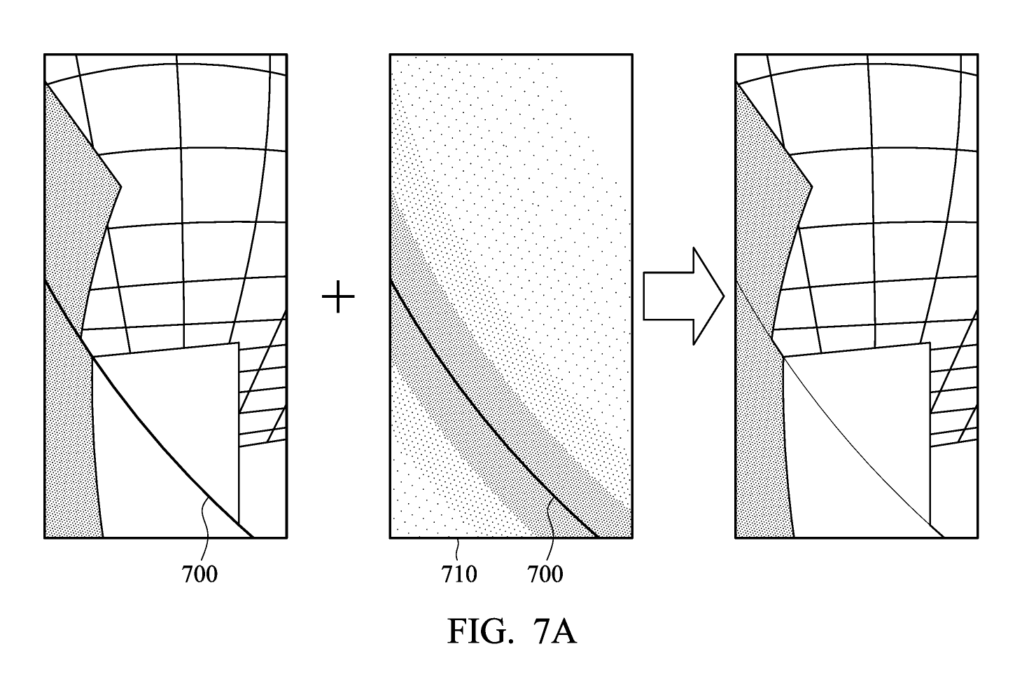

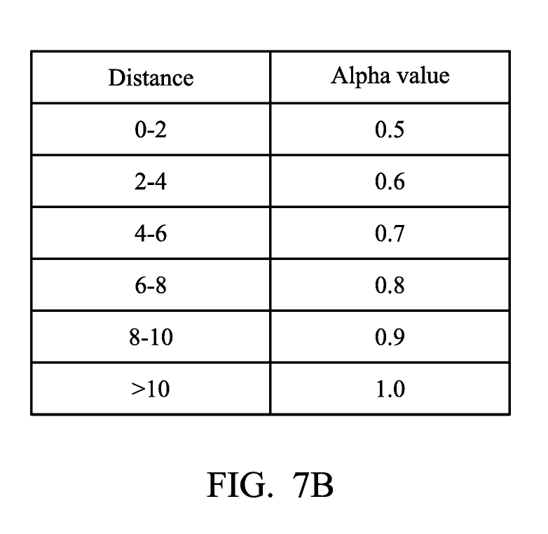

FIG. 7A is a diagram of an image blending process in accordance with an implementation of the disclosure. FIG. 7B is a diagram of a table for determining the alpha value based on the distance information in the distance map in accordance with an implementation of the disclosure. As shown in FIG. 7A, during the warping step, a seam 700 between the two images is first determined based on contents of the two images. A distance from the seam 700 to each pixel of the two images is calculated to generate a distance map 710 which is represented in grayscale level, wherein a darker grayscale level indicates a smaller distance value and a lighter grayscale level indicates a larger distance value. The distance values in the distance map can be used to determine the alpha value ranging from, 0.5-1.0, for alpha blending by table lookup operation with the table shown in FIG. 7B. For example, the distance value ranging from 0-2 is assigned with a same alpha value 0.5, the distance value ranging from 2-4 is assigned with a same alpha value 0.6 and so forth. Then, an alpha blend is utilized to blend the two images at the seam to eliminate irregularities at the seam 700 so that the seam becomes smooth.

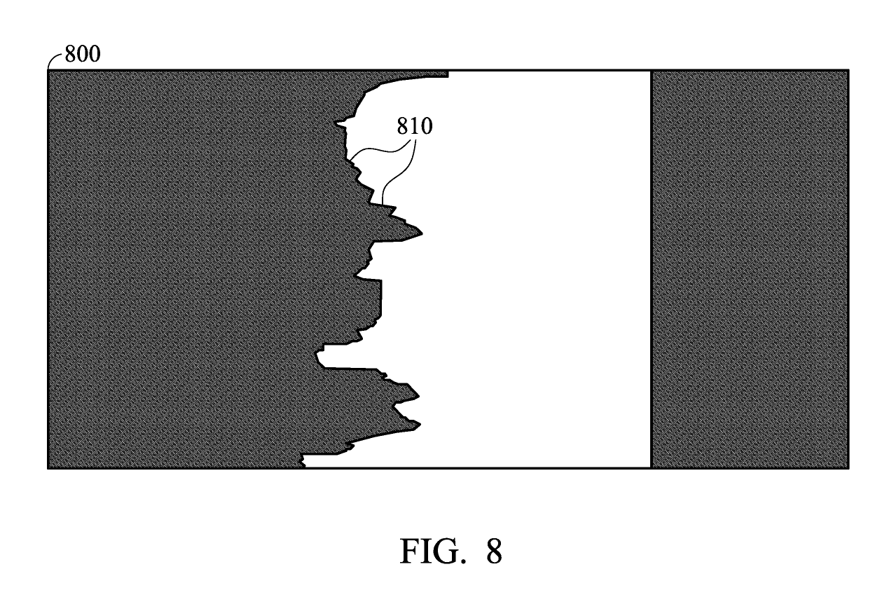

In some implementations, typically, a seam that is not straight, e.g. not based on purely horizontal and vertical segments, is chosen to help hide the seam between the images. Typically, the human eye is sensitive to seams that are straight. The placement of the seam between two images of the panorama can be easily controlled by finding a path with minimum cost based on image-differences calculated between pixels of the overlapping region between these two images. For example, a cost of each pixel of the overlap region can be calculated and a path with minimum cost can be found. The found path with minimum cost is the adjusted seam. Then, the adjusted seam is applied to blend the two images. FIG. 8 is a diagram of a blend mask used to create the panoramic image in accordance with an implementation of the disclosure. As shown in FIG. 8, the blend mask 800 showing a path 810 with minimum cost that can be set as the adjusted seam and be further applied to blend the two images.

In some implementation, the seam can also be determined based on the scene and leads to a dynamic result. In some implementations, the seam between the first image and the second image is dynamically determined according to differences between the first image and the second image relative to the seam.

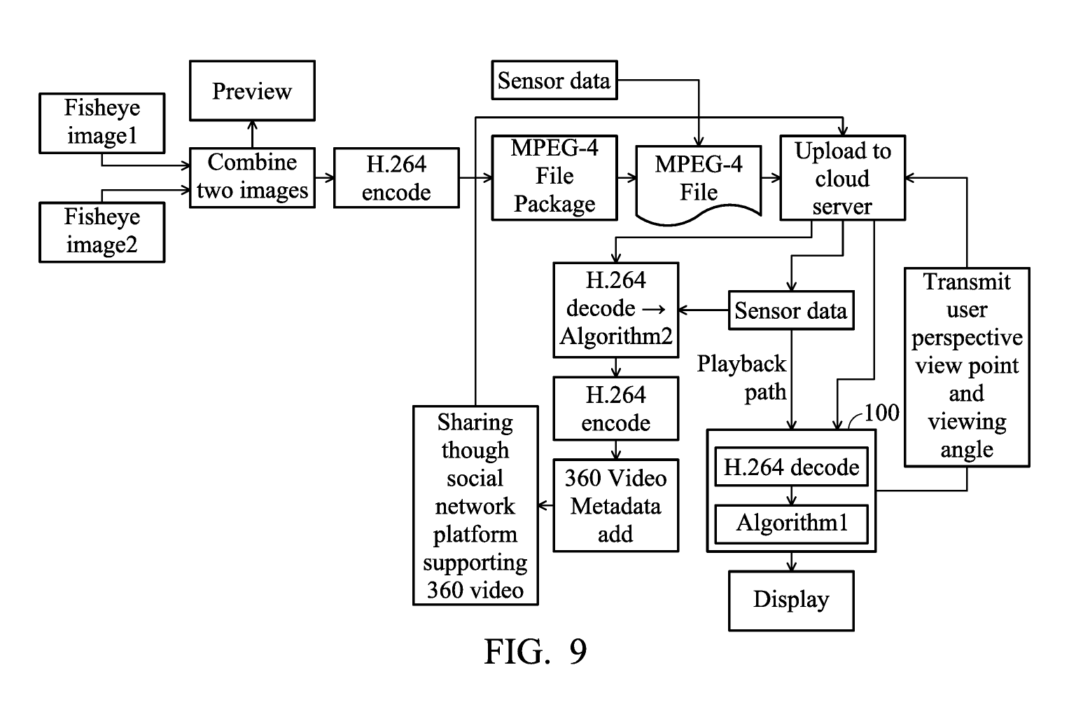

Detailed description of the process for using the method for processing panorama image to upload video and playback the uploaded video from Internet is provided below with reference to FIG. 9.

FIG. 9 is a diagram of an image data processing system for providing video upload and playback with a cloud server (not shown) in accordance with another implementation of the disclosure. The image data processing system 100 and the cloud server can be connected via a wired (e.g., Internet) or wireless network (such as WIFI, Bluetooth, etc.), in order to achieve data transmission between the image data processing system 100 and the cloud server. In this implementation, the cloud server can transmit playback data to the image data processing system 100, enabling the image data processing system 100 to play data to be played in real time. Additionally, detailed description of the image data processing system 100 can be referred to aforementioned detailed description of FIG. 1, and are omitted here for brevity. In other words, the source images can be combined to generate the full panorama image. In this implementation, two fisheye images, Fisheye image1 and Fisheye image2, are inputted and are directly combined into a preview image without any image processing for previewing by the user. The preview image is then encoded to generate encoded image data, such as encoded image bitstream, in any suitable media format compatible with video standards, such as the H.264, MPEG4, HEVC or any other video standard. The encoded image data that is encoded with a H.264 format is added with suitable header information to generate a digital container file (for example, in MP4 format or any other digital multimedia container format) and the digital container file is then uploaded and stored in the cloud server. The digital container file includes sensor data acquired from the sensors of the image data processing system 100. For example, in one implementation, the sensor data can be embedded into the digital container file using a user data field. During image browsing, user's viewpoint and viewing angle information are transmitted from the image data processing system 100 to the cloud server. After receiving the user's viewpoint and viewing angle information from the image data processing system 100, the cloud server retrieves the sensor data from the stored digital container file, determines cropped region images from the preview image according to the user's view point and user viewing angle information and transmits only the cropped or selected portion of images to the image data processing system 100. The image data processing system 100, upon receiving the cropped region images from the cloud server, applies the method of the disclosure to process the cropped images so as to generate a panorama image accordingly and display a corresponding image on the display for previewing by the user.

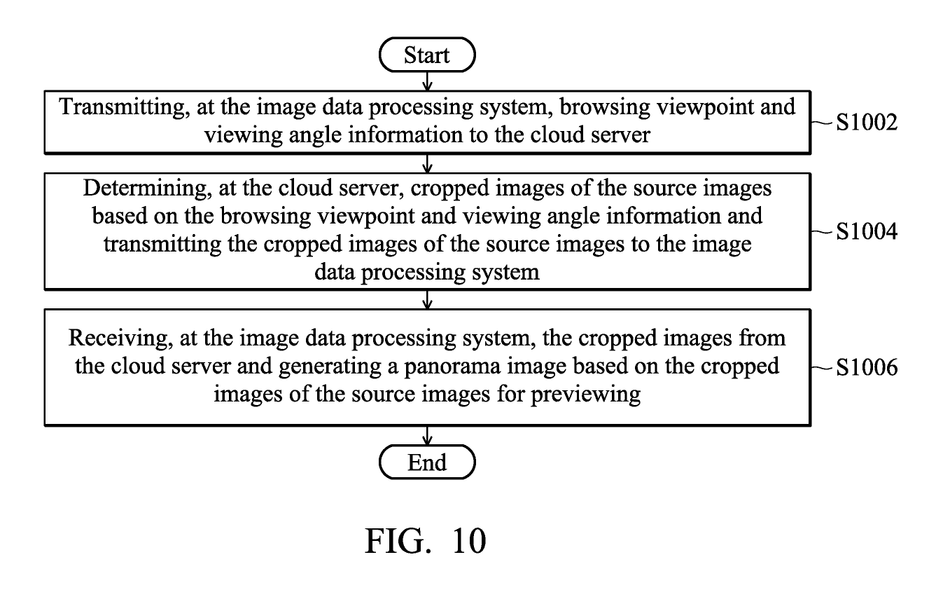

FIG. 10 is a flow chart of a method for processing panorama images performed between an image data processing system and a cloud server in accordance with another implementation of the disclosure. In this implementation, the cloud server is coupled to the image data processing system (e.g., the image data processing system 100 of FIG. 1) and the cloud server stores multiple source images of a full panorama image.

In step S1002, at the image data processing system, browsing viewpoint and viewing angle information is transmitted from the image data processing system to the cloud server.

In step S1004, at the cloud server, upon receiving the browsing viewpoint and viewing angle information, the cloud server determines cropped images of the source images based on the browsing viewpoint and viewing angle information and then transmits the cropped images of the source images to the image data processing system. In one implementation, each of the source images is divided into a plurality of regions. In this implementation, the cropped images are a portion of blocks selected from the blocks, and the cloud server can transmit only the selected blocks of the source images to the image data processing system. In one implementation, the regions in each source image can be equally-sized tiles or blocks. In another implementation, the regions in each overlay image layer can be unequally-sized tiles or blocks.

Then, in step S1006, at the image data processing system, it receives the cropped images from the cloud server and generates a panorama image based on the cropped images of the source images for previewing. It should be noted that the generated panorama image is a partial image of the full panorama image and the partial image will be varied according to different browsing viewpoint and viewing angle information. More details about each step can be referred to embodiments in connection to FIGS. 1, 2 and 3 but not limited thereto. Moreover, the steps can be performed in different sequences and/or can be combined or separated in different implementations.

In one implementation, each of the source images can be decomposed into a number of image blocks and compressed separately for further transmission. For example, each of the frames of the source images or video data is divided into a plurality of regions and the divided regions can be equally-sized tiles or blocks or non-equally-sized tiles or blocks. Each source image can be divided in the same way. The plurality of blocks could be in same data compressed format at the cloud server side and transmitted to and decompressed at the data processing system side. In one implementation, the source images or video data can be decomposed into 32 image or video blocks and only 9 blocks forming the cropped images among the 32 image or video blocks are needed to be transmitted to network, thus greatly reducing the transmission bandwidth required. Moreover, only 9 blocks are needed to be applied to generate the panorama image, thus greatly reducing the computing resource required.

The cloud server can only transmit a selected portion of the source images, thereby greatly reducing transmission bandwidth, for example, without the need for the cloud server to send entire panorama image generated by the entire source images. On the other hand, the image data processing system 100 can only process the selected portion of the input images, thereby saving the computing resource and time needed for the image data processing system 100.

In other implementations, if the panorama image is to be shared on the social network platform (e.g., Facebook or Google), the image data processing system 100 may further apply another method, which is a normal processing version fulfill the standard spherical format to social network supporting 360 video, to process entire images so as to generate a panorama image accordingly to share the panorama image through the social network platform supporting 360 video.

In some implementations, the image data processing system 100 may further apply the method of the disclosure to process the inputted fisheye images to generate a preview image for previewing by the user.

In some implementations, playback of the panorama image or video can be performed on the fly on the decoder side or be performed off line on the encoder side, thereby providing more flexibility in video playback. The term “on the fly” means that playback of the video is performed in real time during the video recording. The other term “off line” means that sharing of the video is performed after the video recording is finished.

In some implementations, several optimization methods are provided for the purpose of memory optimization. To be more specific, due to the limitation of cache sizes on mobile platforms, the way to access data in memory should fit the memory locality principle. Moreover, as the size and partition shapes of image blocks are pre-defined, it may influence the memory access behavior. For this reason, not only needs to lower the frequency of accessing memories, but also needs to lower the sizes of the accessing buffers. As different FOVs may lead to different accessing ranges of the frame buffers, there may be higher cache miss rate. Thus, memory optimization is required.

In one implementation, the memory optimization can be achieved by reducing the image size of the source image cached in the frame buffer according to the browsing viewing angle information, e.g., the target FOV of the final image (i.e., the perspective or panorama image for viewing or previewing), and the image size cached in the frame buffer can be reduced by down-sampling the original source images as the target FOV is greater than a predetermined degree (e.g., 180 degree). For example, when the predetermined degree is 180 degree and the target FOV is set to be 190, the original source images can be down-sampled to reduce the image size being cached, e.g., reducing the image size by ½. Accordingly, the required storage of the frame buffer can be significantly reduced.

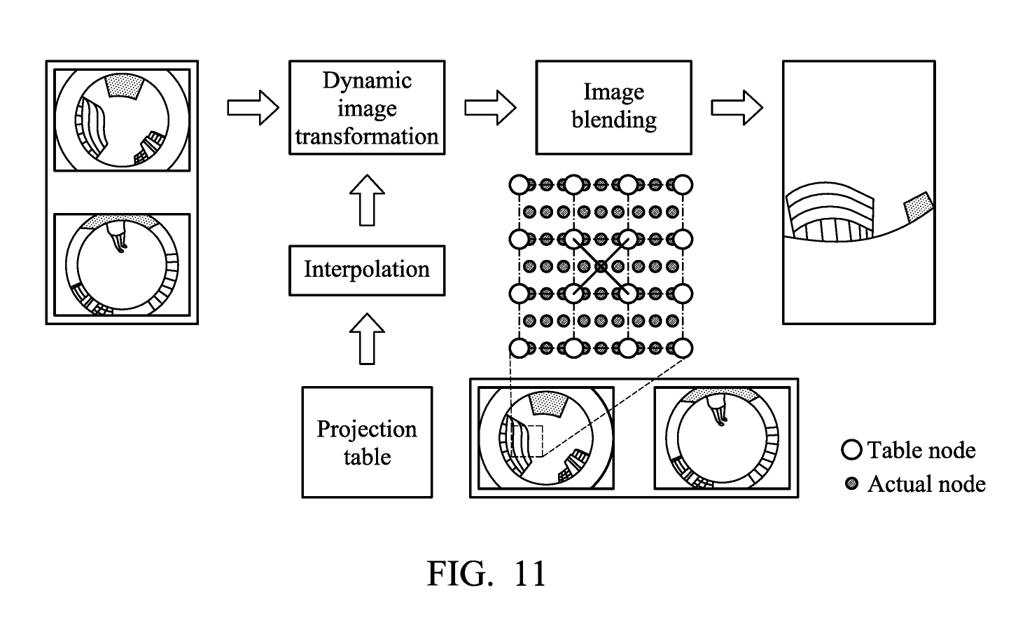

In another implementation, the memory optimization can be achieved by reducing the size of mapping table or projection table of the spherical projection during the spherical projection process. In this implementation, the size of the mapping table or the projection table can be reduced by interpolating values from a smaller table rather than accessing the direct coordinates from the original table with larger size. To be more specific, the step of transferring or mapping the cropped images of the source images to spherical images based on the browsing viewpoint and viewing angle information may further comprise using a spherical projection with a mapping table to transfer or map the cropped images of the source images to the spherical images, wherein the cropped images of the source images may include a first set of pixel points and a second set of pixel points, and values of the first set of pixel points are obtained from the mapping table and values of the second sets of the pixel points are calculated by performing an interpolation operation on the first set of pixel points for the spherical projection process. In some other embodiments, the cropped images of the source images may only include the above-mentioned first set of pixel points or may only include the above-mentioned second set of pixel points. FIG. 11 is a diagram of a mapping table for the spherical projection process in accordance with an implementation of the disclosure. As shown in FIG. 11, the cropped image includes black nodes and white nodes, each node representing a pixel point within the cropped image. White nodes (i.e., a first set of pixel points) indicate nodes selected from the nodes of the cropped image to form the mapping table for the spherical projection process and black nodes (i.e., a second set of pixel points) indicate remaining nodes not being selected (a second set of pixel points) from the original image, wherein values of the white nodes can be stored in the frame buffer and values of unselected nodes (i.e., the black nodes) can be calculated by interpolating values of the corresponding white nodes. Accordingly, the required storage of the frame buffer for storing the mapping table can be significantly reduced.

In another implementation, the memory optimization can be achieved by reusing the frame buffer during the image blending process. For example, in pyramid blending, the original images are decomposed into several frequency components, so large frame buffer is needed to temporarily store these components. Pyramid blending is applied to blend the seam boundaries using multiple blending levels, which is decided based on a corresponding distance map and the pixel positions. Pyramid blending is a technique that decomposes images into a set of band-pass components (i.e., Laplacian pyramids or Laplacian images) and blends them using different blending window sizes respectively. After that, these blended band-pass components are added to form the desired image with no obvious seams. The weighting coefficients in the blending procedure are dependent on the distance from each pixel to the seam boundary.

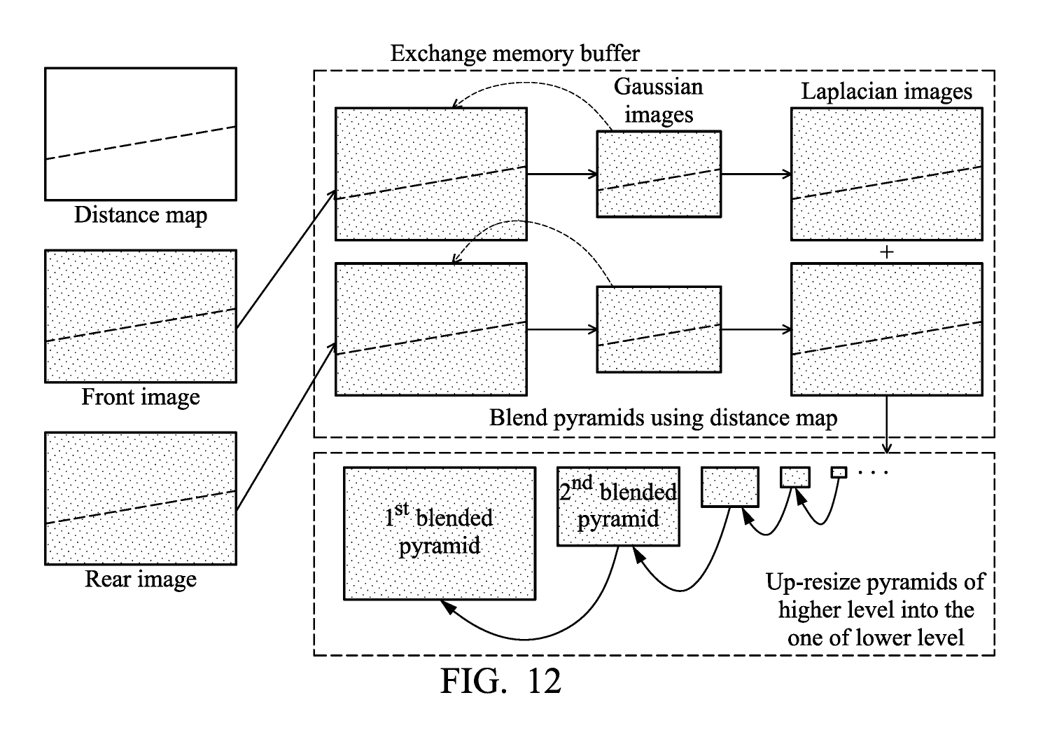

FIG. 12 is a diagram of a memory buffer reusing of image blending process in accordance with an implementation of the disclosure. As shown in FIG. 12, the distance map, front and rear images (e.g., two cropped images) are the input for the pyramid blending with multiple levels and three fixed memory buffers are used to put intermediate data for Gaussian-image and Laplacian-image generation for each of the front and rear images. To be more specific, three buffers are respectively allocated for storing an initial image, a Gaussion-image and a Laplacian-image generated at each level of the pyramid blending. In each level of the pyramid blending, the Gaussion-image, which is intermediate data for Gaussian-image generation, is a low pass filtered version of the initial image and the Laplacian-image, which is intermediate data for Laplacian-image generation, is the difference between the initial image and the low pass filtered image. In each level of the pyramid blending, the buffer allocated for storing the Gaussian image and the buffer allocated for storing the initial image used in the previous level can be switched mutually to be used for current level of the pyramid such that the memory buffer can be effective reused. Accordingly, the required storage of the frame buffer can be significantly reduced.

In view of the above implementations, an image data processing system and an associated method for processing panorama images and method for blending a first image and a second image are provided. With the method for processing panorama image of the disclosure, only a selected portion of the source images are needed to be transmitted through network and only a portion of source images are needed to be applied or processed to generate the panorama image, thus greatly reducing the computing resource required. Accordingly, the required storage of the frame buffer can be significantly reduced, and thus the required memory bandwidth can be reduced and decoding complexity can also be saved. Moreover, playback of the video can be performed on the fly on the decoder side or video sharing can be performed off line on the encoder side, thereby providing more flexibility in real time viewing for a panorama image with a scene of 360 degree.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus or a hardware and software apparatus. An apparatus may be implemented in, for example, appropriate hardware, software, and firmware. The methods may be implemented in an apparatus such as, for example, a processor, which refers to any processing device, including, for example, a computer, a microprocessor, an integrated circuit, or a programmable logic device.

While the disclosure has been described by way of example and in terms of the preferred embodiments, it is to be understood that the disclosure is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for processing images in an image data processing system, comprising:
receiving a plurality of source images, wherein the source images at least comprise overlapping portions;
receiving browsing viewpoint and viewing angle information;
determining cropped images of the source images based on the browsing viewpoint and viewing angle information; and
generating a perspective or panorama image for viewing or previewing based on the cropped images of the source images.

2. The method as claimed in claim 1, further comprising:
down-sampling the source images when a field-of-view (FOV) of the perspective or panorama image is greater than a predetermined threshold value.

3. The method as claimed in claim 1, wherein generating the perspective or panorama image based on the cropped images of the source images further comprises:
transferring or mapping the cropped images of the source images to spherical images based on the browsing viewpoint and viewing angle information;
warping and rotating the spherical images to generate rotated images based on the viewing angle information and sensor data collected by a sensor of the image data processing system; and
blending the rotated images to generate the perspective or panorama image based on a distance map.

4. The method as claimed in claim 3, wherein transferring the cropped images of the source images to spherical images based on the browsing viewpoint and viewing angle information further comprises:
using a spherical projection with a mapping table to transfer the cropped images of the source images to the spherical images,
wherein the cropped images of the source images include a first set of pixel points and a second set of pixel points, and values of the first set of pixel points are obtained from the mapping table and values of the second sets of the pixel points are calculated by performing an interpolation operation on the first set of pixel points during the spherical projection process.

5. The method as claimed in claim 2, wherein blending the rotated images to generate the perspective or panorama image based on the distance map comprises using an alpha blend to blend the rotated images at a seam boundary to eliminate irregularities or discontinuities surrounds the seam caused by the overlapping portions of the source images.

6. The method as claimed in claim 2, wherein the step of blending the rotated images to generate the perspective or panorama image based on the distance map comprises using a pyramid blending with a plurality of levels to blend the rotated images based on the distance map, wherein three buffers are respectively allocated for storing an initial image, a Gaussion-image and a Laplacian-image generated at each level of the pyramid blending, and the buffer allocated for storing the initial image and the buffer allocated for storing the Gaussion-image are switched mutually at next level of the pyramid blending.

7. The method as claimed in claim 2, wherein rotating the spherical images based on the sensor data further comprises:
determining a projection plane based on the viewing angle information;
rotating the projection plane based on the sensor data; and
rotating the spherical images to generate the rotated images using the rotated projection plane.

8. The method as claimed in claim 1, further comprising:
determining whether the cropped images crosses through more than one source image;
blending the cropped images of the source images to generate the perspective or panorama image when determining that the cropped images cross through two or more of the source images; and
directly outputting the cropped images as the perspective or panorama image when determining that the cropped images do not cross through more than one source image.

9. The method as claimed in claim 1, wherein each of the source images is divided into a plurality of blocks and the cropped images are selected from a portion of the blocks.

10. A method for blending a first image and a second image in an image data processing system to generate a blended image, comprising:
determining a seam between the first image and the second image based on corresponding contents of the first image and the second image;
calculating a distance between the seam and at least one pixel of the first image and the second image to generate a distance map; and
blending the first image and the second image to generate the blended image according to the distance map.

11. The method as claimed in claim 10, wherein the seam between the first image and the second image is dynamically determined according to a difference between the first image and the second image relative to the seam.

12. The method as claimed in claim 10, wherein blending the first image and the second image to generate the blended image according to the distance map further comprises using an alpha blend to blend the first image and the second image at the seam to eliminate irregularities or discontinuities surrounds the seam, wherein a blending ratio for the alpha blend is determined based on the distance map.

13. An image data processing system, comprising:
at least one image input interface, configured to receive a plurality of source images, wherein the source images at least comprise overlapping portions;
a processor coupled to the image input interface, configured to receive the source images from the image input interface, receive browsing viewpoint and viewing angle information, determine cropped images of the source images based on the browsing viewpoint and viewing angle information and generate a perspective or panorama image for viewing or previewing based on the cropped images of the source images.

14. The image data processing system as claimed in claim 13, further comprising a sensor for providing sensor data and wherein the processor is further configured to transfer the cropped images of the source images to spherical images based on the browsing viewpoint and viewing angle information, warp and rotate the spherical images to generate rotated images based on the viewing angle information and the sensor data collected by the sensor, and blend the rotated images to generate the perspective or panorama image based on a distance map.

15. The image data processing system as claimed in claim 14, wherein the processor is further configured to use an alpha blend to blend the rotated images at a seam boundary to eliminate irregularities or discontinuities surrounds the seam caused by the overlapping portions of the source images.

16. The image data processing system as claimed in claim 14, wherein the processor is further configured to determine a projection plane based on the viewing angle information, rotate the projection plane based on the sensor data and rotate the spherical images to generate the rotated images using the rotated projection plane.

17. The image data processing system as claimed in claim 14, wherein the processor is further configured to determine whether the cropped images crosses through more than one source image, and the processor blends the cropped images of the source images to generate the perspective or panorama image when determining that the cropped images cross through two or more of the source images or directly outputs the cropped images as the perspective or panorama image when determining that the cropped images do not cross through more than one source image.

18. The image data processing system as claimed in claim 13, wherein each of the source images is divided into a plurality of blocks and the cropped images are selected from a portion of the blocks.

19. A method for processing images performed between an image data processing system and a cloud server coupled thereto, wherein the cloud server stores a plurality of source images, comprising:
receiving, at the cloud server, browsing viewpoint and viewing angle information from the image data processing system;
determining, at the cloud server, cropped images of the source images based on the browsing viewpoint and viewing angle information; and
transmitting, at the cloud server, the cropped images of the source images to the image data processing system;
such that upon receiving the cropped images from the cloud server, the image data processing system generates a perspective or panorama image based on the cropped images of the source images for viewing or previewing.

20. The image data processing system as claimed in claim 19, wherein each of the source images is divided into a plurality of blocks and the cropped images are a portion of blocks selected from the blocks, and the cloud server transmits the selected blocks of the source images to the image data processing system, wherein the plurality of blocks are in same data compressed format at the cloud server side and transmitted to and decompressed at the data processing system side.
